(19) United States
(12) Patent Application Publication
(10) Pub. No.: US 2009/0326782 A1
(43) Pub. Date: Dec. 31, 2009

(54) AIRCRAFT GAS TURBINE ENGINE CONTROLLER WITH REMOVABLE MEMORY AND DIAGNOSTIC SYSTEM AND METHOD THEREFOR

(75) Inventor: Larry J. Nunn, Goodyear, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc., Morristown, NJ (US)

(21) Appl. No.: 12/106,702

(22) Filed: Apr. 21, 2008

(51) Int. Cl. G06F 19/00

(52) U.S. Cl. 701/100

(57) ABSTRACT

A system and method of analyzing aircraft gas turbine engine performance data includes receiving, in an engine controller, engine performance data representative of a plurality of aircraft gas turbine engine parameters. At least a portion of the received engine performance data are stored in a fixed memory device that is fixedly coupled to a fixed-memory mount in the engine controller, and in a removable memory device that is non-fixedly coupled to a removable memory mount in the engine controller in a manner that allows the removable memory device to be hand-removable from the removable memory mount. The removable memory device is removed from the removable memory mount in the engine controller, and inserted in a port of a computing device that is not coupled to the engine controller.

### TECHNICAL FIELD

The present invention generally relates to aircraft engine controllers and, more particularly, to an aircraft gas turbine engine controller with redundant, removable memory for storing engine performance data.

### BACKGROUND

Aircraft gas turbine engines are used to provide both propulsion and, in many instances, may also be used to drive various rotating components such as, for example, generators, compressors, and pumps, to thereby supply electrical, pneumatic, and/or hydraulic power. Aircraft gas turbine engines may also be used to supply compressed air to the aircraft's environmental control system (ECS). During flight, the aircraft main propulsion engines, in addition to providing propulsion, typically supply the electrical, pneumatic, hydraulic, and/or ECS air. However, when an aircraft is on the ground, its main engines may not be operating. Moreover, in some instances the main engines may not be capable of supplying power. Thus, many aircraft may also include one or more auxiliary power units (APUs).

Many aircraft gas turbine engines, whether implemented as main propulsion engines or APUs, are controlled via an engine control device, such as an electronic engine controller (EEC) or a full authority digital engine controller (FADEC). During engine operation, the engine controllers not only control the operation of an associated gas turbine engine, but also collect and store engine performance data that are representative of a plurality of gas turbine engine parameters. The stored engine performance data may be used to, among other things, assess overall engine performance, troubleshoot an engine fault, and/or determine engine health.

Typically, an aircraft technician retrieves the stored engine performance data from an aircraft engine controller by transporting a notebook computer (or other suitable device) out to the aircraft, interconnecting the computer and the engine controller via a suitable hardware connection (e.g., an RS-422 cable), and downloading the stored data to the computer. The computer is then transported back to a suitable shop or laboratory, where the retrieved engine performance data may be analyzed.

Although the above-described system and method for collecting, storing, and retrieving aircraft engine performance data are generally safe and reliable, there are certain drawbacks associated therewith. For example, it can be time consuming and inconvenient for an aircraft technician to transport a computing device to the aircraft and interconnect it with the aircraft engine controllers. Moreover, the intervals between performance data downloads may vary depending, for example, on the capacity of the memory used to store the engine performance data. This can also add to the inconvenience and cost.

Hence, there is a need for a system and method of retrieving stored engine performance data that is relatively less inconvenient and relatively less costly than current systems and methods. The present invention addresses at least this need.

### BRIEF SUMMARY

In one embodiment, and by way of example only, an aircraft gas turbine engine controller includes a processor, a fixed memory device, and a removable memory device. The processor is coupled to receive engine performance data representative of a plurality of aircraft gas turbine engine parameters. The processor is configured to generate and supply engine control signals based, at least in part, on the engine performance data, and to selectively transmit at least a portion of the engine performance data for storage. The fixed memory device is in operable communication with the processor to receive and store the engine performance data selectively transmitted by the processor. The fixed memory device is fixedly coupled to a fixed-memory mount. The removable memory device is in operable communication with the processor to receive and store the engine performance data selectively transmitted by the processor. The removable memory device is non-fixedly coupled to a removable memory mount in a manner that allows the removable memory device to be hand-removable from the removable memory mount.

In another exemplary embodiment, an aircraft gas turbine engine diagnostic system includes a computing device and an engine controller. The computing device includes a port configured to receive a removable memory device. The computing device is operable to retrieve engine performance data stored on the removable memory device, and to run engine diagnostics based on the retrieved engine performance data. The engine controller includes a processor, a fixed memory device, and a removable memory device. The processor is coupled to receive the engine performance data and is configured to generate and supply engine control signals based, at least in part, on the engine performance data, and to selectively transmit at least a portion of the engine performance data for storage. The fixed memory device is in operable communication with the processor to receive and store the engine performance data selectively transmitted by the processor. The fixed memory device is fixedly coupled to a fixed-memory mount. The removable memory device is in operable communication with the processor to receive and store the engine performance data selectively transmitted by the processor. The removable memory device is non-fixedly coupled to a removable memory mount in a manner that allows the removable memory device to be hand-removable from the removable memory mount and inserted into the port of the computing device.

In still another exemplary embodiment, a method of analyzing aircraft gas turbine engine performance includes receiving, in an engine controller, engine performance data representative of a plurality of aircraft gas turbine engine parameters. At least a portion of the received engine performance data are stored in a fixed memory device that is fixedly coupled to a fixed-memory mount in the engine controller, and in a removable memory device that is non-fixedly coupled to a removable memory mount in the engine controller in a manner that allows the removable memory device to be hand-removable from the removable memory mount. The removable memory device is removed from the removable memory mount in the engine controller, and inserted in a port of a computing device that is not coupled to the engine controller. The engine performance data stored on the removable memory device are retrieved, and the health status of the aircraft gas turbine engine is determined based on the retrieved engine performance data.

Other desirable features and characteristics of the present invention will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 depicts a schematic representation of an embodiment of an exemplary aircraft gas turbine engine control system;

FIG. 2 is a functional block diagram of an engine controller that may be used to implement the engine control system of FIG. 1; and

FIG. 3 depicts a system and method for analyzing data collected during operation of the system of FIG. 1.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. In this regard, although the present embodiment is, for convenience of explanation, depicted and described as being implemented in combination with a multi-spool turbofan gas turbine jet engine, it will be appreciated that it can be implemented in combination with various other types of aircraft gas turbine engines that may be used for propulsion, power generation, or both.

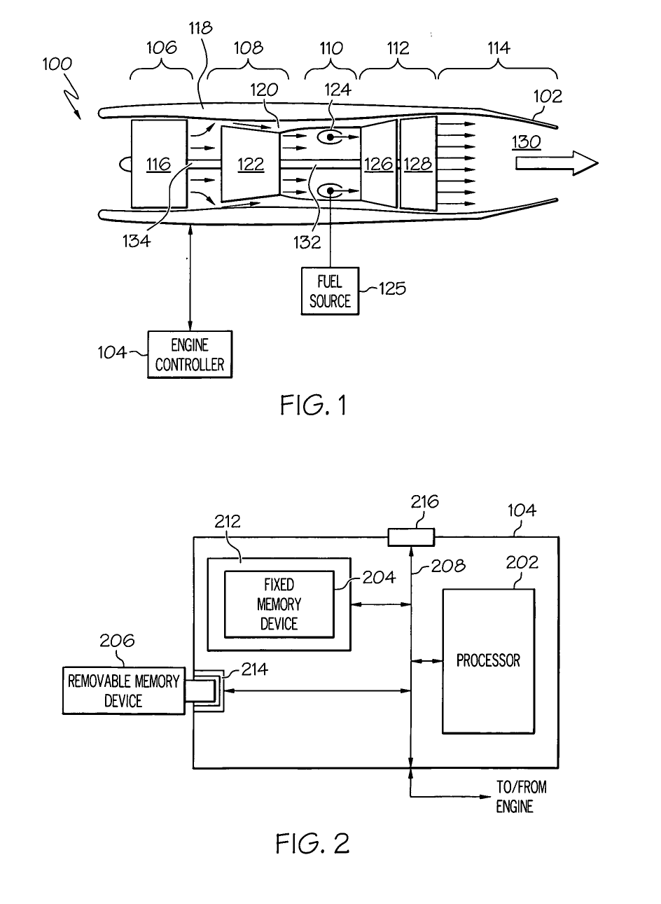

Turning now to FIG. 1, an embodiment of an exemplary aircraft gas turbine engine control system 100 is shown in schematic form. The system 100 includes an aircraft gas turbine propulsion engine 102 and an engine controller 104. In the depicted embodiment, the propulsion engine 102 is a multi-spool turbofan gas turbine jet engine, and includes an intake section 106, a compressor section 108, a combustion section 110, a turbine section 112, and an exhaust section 114. The intake section 106 includes a fan 116, which is mounted in a fan case 118. The fan 116 draws air into the intake section 106 and accelerates it. A fraction of the accelerated air exhausted from the fan 116 is directed through a bypass section 120 disposed between the fan case 118 and an engine cowl, and provides a forward thrust. The remaining fraction of air exhausted from the fan 116 is directed into the compressor section 108.

The compressor section 108 may include one or more compressors 122, which raise the pressure of the air directed into it from the fan 116, and directs the compressed air into the combustion section 110. In the depicted embodiment, only a single compressor 122 is shown, though it will be appreciated that one or more additional compressors could be used. In the combustion section 110, which includes a combustor assembly 124, the compressed air is mixed with fuel supplied from a fuel source 125. The fuel/air mixture is combusted, and the high energy combusted air is then directed into the turbine section 112.

The turbine section 112 includes one or more turbines. In the depicted embodiment, the turbine section 112 includes two turbines, a high pressure turbine 126, and a low pressure turbine 128. However, it will be appreciated that the engine 100 could be configured with more or less than this number of turbines. No matter the particular number, the combusted air from the combustion section 110 expands through each turbine, causing it to rotate. The air is then exhausted through a propulsion nozzle 130 disposed in the exhaust section 114, providing additional forward thrust. As the turbines 126 and 128 rotate, each drives equipment in the propulsion engine 102 via concentrically disposed shafts or spools. Specifically, the high pressure turbine 126 drives the compressor 122 via a high pressure spool 132, and the low pressure turbine 128 drives the fan 116 via a low pressure spool 134.

The engine controller 104 is coupled to and controls the propulsion engine 102. The engine controller 104 may be implemented as a FADEC (Full Authority Digital Engine Controller) 104 or any other suitable electronic engine controller (EEC). The engine controller 104, as is generally known, receives various commands and sensor signals and, in response to these commands and sensor signals, appropriately controls engine operation. The engine controller 104 additionally receives and stores various engine performance data representative of a plurality of engine parameters, which may be supplied from various sensors within the engine 102, for various uses after engine shutdown. Such uses may include, for example, running various engine performance diagnostics and/or analyzing engine health.

Turning now to FIG. 2, a functional block diagram of the engine controller 104 is depicted, and includes one or more processors 202 (only one depicted) and a plurality of memory devices. The memory devices include one or more fixed memory devices 204 (only one depicted) and one or more removable memory devices 206 (only one depicted). The processor 202 is coupled to receive the above-mentioned commands and engine performance data and is configured, in response to the received commands and data, to generate and supply control signals to the engine 102. The processor 202 is additionally configured to selectively transmit, via a suitable communication bus 208, at least a portion of the engine performance data for storage in the fixed memory device 204 and the removable memory device 206.

The fixed memory device 206, as this moniker connotes, is fixedly coupled to a fixed memory mount 212. The fixed memory device is in operable communication with the processor 202 via the communication bus 208 to receive and store the engine performance data that are selectively transmitted by the processor 202. The fixed memory device 204, as may be appreciated, may be implemented using any one of numerous suitable magnetic, optical, or solid-state storage devices, now known or developed in the future, that may be fixedly coupled within the engine controller 104 and used to store engine performance data. Preferably, the fixed memory device 204 is implemented using any one of numerous suitable non-volatile memory devices that may be cleared upon receipt of a suitable command from the processor 202.

The removable memory device 206, similar to the fixed memory device 204, is in operable communication with the processor 202 via the communication bus 208 to receive and store the engine performance data that are selectively transmitted by the processor 202. However, the removable memory device 206, unlike the fixed memory device 204, is non-fixedly coupled to an associated removable memory mount 214. In particular, the removable memory device 206 is non-fixedly coupled to the removable memory mount 214 in a manner that allows the removable memory device 206 to be hand-removable from the removable memory mount 214.

It will be appreciated that the removable memory device 206 and the removable memory mount 214 may be variously configured and implemented. For example, the one or both of removable memory device 206 and removable memory mount 214 may be disposed wholly within the engine controller 104 or partially within the engine controller 104. Moreover, the removable memory device 206 and the associated removable memory mount 214, may be implemented using any one of numerous magnetic, optical, or solid-state storage devices, now known or developed in the future, that allow for hand-removal of the removable memory device 214. Such storage devices include, for example, numerous and varied magnetic, optical, and solid-state disks, drives, cartridges, and cards. It will be appreciated, of course, that the removable memory mount 214 that is used will be compatible with the removable memory device 206. In the depicted embodiment, the removable memory device 206 is implemented using a suitable flash memory storage device, such as a universal serial bus (USB) flash memory device (e.g., a “thumb drive”), and the removable memory mount 214 is a USB port.

Before proceeding further, it is noted that the processor 202 preferably transmits the same engine performance data to both the fixed and removable memory devices 204, 206. Thus, the fixed and removable memory devices 204, 206 are, in this respect, redundant. With this configuration, in the unlikely event one of these memory devices 204, 206 were to become fully or partially inoperable, the engine performance data would still be stored and be able to be retrieved from the engine controller 104. Hence, as FIG. 2 further depicts, the engine controller 104 preferably includes a suitable input/output (I/O) port 216 to which a portable computing device (not illustrated in FIG. 2) may be connected, if needed or desired, to retrieve the engine performance data from the fixed memory device 204.

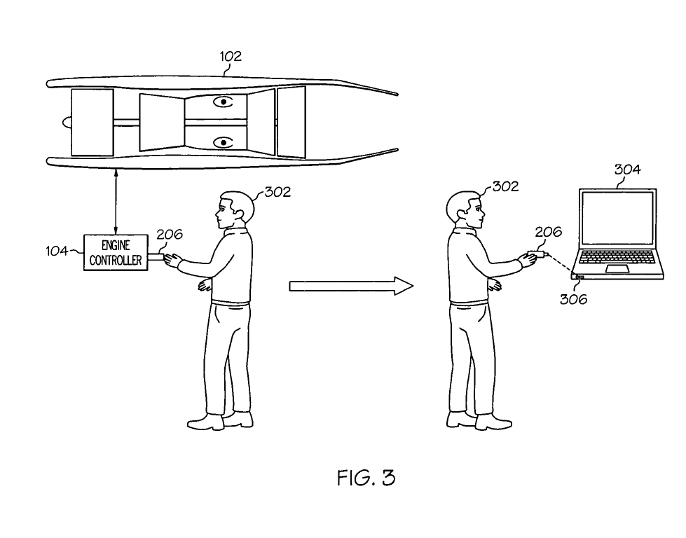

With reference now to FIG. 3, a particular method of determining the health status of the engine 100 will be described. As was noted above, the an engine controller 104 receives, from the engine 102, engine performance data representative of a plurality of aircraft gas turbine engine parameters. The processor 202, among other things, causes at least a portion of the received engine performance data to be stored in both the fixed memory device 202 and in the removable memory device 206. Upon occurrence of an appropriate event, such as a detected engine fault or at a periodic maintenance or inspection period, a technician 302 (or other authorized personnel) hand-removes the removable memory device 206 from the removable memory mount 214 in the engine controller 104.

The technician 302, after removing the removable memory device 206, may then transport the removable memory device 206 to a suitable computing device 304 that is not coupled to the engine controller 104. It will be appreciated that the computing device 304 may be any one of numerous suitable computing devices such as, for example, a notebook computer, a personal computer workstation, or a suitable application-specific device. No matter the particular implementation of the computing device 304, it preferably includes at least one port 306 that is compatible with the removable memory device 206. The technician 302, upon reaching the computing device 304, inserts the removable memory device 206 into the port 306. The computing device 304, using suitable software stored thereon, may then be commanded to retrieve the engine performance data stored on the removable memory device 206, and determine the health status of the aircraft gas turbine engine 102 based on the retrieved engine performance data. It will be appreciated that the controller 104 may be configured, either automatically or in response to an input from a user (such as the technician 302), to clear the engine performance data stored in the fixed memory device 204.

The systems and methods described herein allow stored engine performance data to be retrieved and analyzed in a relatively convenient and relatively cost-effective manner, as compared with current systems and methods.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. An aircraft gas turbine engine controller, comprising:
a processor coupled to receive engine performance data representative of a plurality of aircraft gas turbine engine parameters, the processor configured to (i) generate and supply engine control signals based, at least in part, on the engine performance data and (ii) selectively transmit at least a portion of the engine performance data for storage;
a fixed memory device in operable communication with the processor to receive and store the engine performance data selectively transmitted by the processor, the fixed memory device fixedly coupled to a fixed-memory mount; and
a removable memory device in operable communication with the processor to receive and store the engine performance data selectively transmitted by the processor, the removable memory device non-fixedly coupled to a removable memory mount in a manner that allows the removable memory device to be hand-removable from the removable memory mount.

2. The controller of claim 1, wherein the removable memory device is selected from the group consisting of a removable magnetic memory device, a removable optic memory device, and a removable solid-state memory device.

3. The controller of claim 1, wherein the removable memory device comprises magnetic memory.

4. The controller of claim 1, wherein the removable memory device comprises optical memory.

5. The controller of claim 1, wherein the removable memory device comprises solid-state memory.

6. The controller of claim 1, wherein:
the removable memory mount comprises a universal serial bus (USB) port; and
the removable memory device comprises a USB flash memory storage device.

7. The controller of claim 1, wherein the removable memory device comprises a flash memory storage device.

8. The controller of claim 1, further comprising:
an input/output (I/O) port in operable communication with at least the fixed memory device, the I/O port adapted to couple to an external computing device.

9. An aircraft gas turbine engine diagnostic system, comprising:
a computing device comprising a port configured to receive a removable memory device, the computing device operable to retrieve engine performance data stored on the removable memory device, the engine performance data representative of a plurality of aircraft gas turbine engine parameters, the computing device further operable to run engine diagnostics based on the retrieved engine performance data; and
an engine controller comprising:
a processor coupled to receive the engine performance data and configured to (i) generate and supply engine control signals based, at least in part, on the engine performance data and (ii) selectively transmit at least a portion of the engine performance data for storage;
a fixed memory device in operable communication with the processor to receive and store the engine performance data selectively transmitted by the processor, the fixed memory device fixedly coupled to a fixed-memory mount; and
the removable memory device in operable communication with the processor to receive and store the engine performance data selectively transmitted by the processor, the removable memory device non-fixedly coupled to a removable memory mount in a manner that allows the removable memory device to be hand-removable from the removable memory mount and inserted into the port of the computing device.

10. The system of claim 9, wherein the removable memory device is selected from the group consisting of a removable magnetic memory device, a removable optic memory device, and a removable solid-state memory device.

11. The system of claim 9, wherein the removable memory device comprises magnetic memory.

12. The system of claim 9, wherein the removable memory device comprises optical memory.

13. The system of claim 9, wherein the removable memory device comprises solid-state memory.

14. The system of claim 9, wherein:
the removable memory mount comprises a universal serial bus (USB) port; and
the removable memory comprises a USB flash memory storage device.

15. The system of claim 9, wherein the removable memory comprises a flash memory storage device.

16. The system of claim 9, wherein the engine controller further comprises:
an input/output (I/O) port in operable communication with at least the fixed memory device, the I/O port adapted to couple to the computing device.

17. A method of analyzing performance of an aircraft gas turbine engine, comprising the steps of:
receiving, in an engine controller, engine performance data representative of a plurality of aircraft gas turbine engine parameters;
storing at least a portion of the received engine performance data in a fixed memory device that is fixedly coupled to a fixed-memory mount in the engine controller; and
storing the at least a portion of the received engine performance data in a removable memory device that is non-fixedly coupled to a removable memory mount in the engine controller in a manner that allows the removable memory device to be hand-removable from the removable memory mount;
removing the removable memory device from the removable memory mount in the engine controller;
inserting the removable memory device in a port of a computing device that is not coupled to the engine controller;
retrieving the engine performance data stored on the removable memory device; and
analyzing the performance of the aircraft gas turbine engine based on the retrieved engine performance data.

18. The method of claim 17, further comprising:
clearing the engine performance data stored in the fixed memory device.
